(19) United States
(12) Patent Application Publication
(10) Pub. No.: US 2008/0027361 A1
(43) Pub. Date: Jan. 31, 2008

(54) Vibrating ring for sexual stimulation

(76) Inventor: Chien-Feng Lin, Sindian City (TW)

Correspondence Address: DAVID I. ROCHE;BAKER & MCKENZIE LLP, 130 EAST RANDOLPH DRIVE, CHICAGO, IL, 60601, US

(21) Appl. No.: 11/492,647

(22) Filed: Jul. 25, 2006

(51) Int. Cl. A61H 1/00

(52) U.S. Cl. 601/46

(57) ABSTRACT

The invention provides a vibrating ring, which includes a ring and a vibrating device mounted with the ring. The vibrating device comprises a casing, a power module, a resilient base, a vibrating motor and a massage pad connected with the vibrating motor through an oscillating rod. The power module lodges a battery, and is provided with a rotary or push switch. When turned on, the vibrating device produces vibrations which are transmitted to the ring and make the massage pad oscillate.

### FIELD OF THE INVENTION

The present invention generally relates to sexual stimulating devices, and more particularly to a vibrating ring configured to provide enhanced sexual pleasure by applying an effective vibrating stimulation.

### DESCRIPTION OF THE RELATED ART

U.S. Pat. No. 6,907,883 describes a vibrating ring implemented as an apparatus for sexual stimulation. The vibrating ring includes a plastic ring having a pocket mounted with a vibrating device. The pocket is formed with the ring in a single body, and has a surface provided with a protrusion. The vibrating device is internally mounted with a vibrating motor having an eccentric mass rotor. When the vibrating device is turned on, the rotation of the motor creates vibrations which propagate to the ring body and its protrusion on the surface of the pocket.

Unfortunately, the operation of the foregoing vibrating ring does not bring satisfactory results. One reason may be that the vibration mode produced by the vibrating device fails to provide an effective stimulation through the ring.

Therefore, there is presently a need for an improved apparatus that can provide enhanced performance and effectively stimulate sexual pleasure.

### SUMMARY OF THE INVENTION

The present application describes a vibrating ring for sexual stimulation.

In one embodiment, the vibrating ring comprises a ring for encircling a penis and provided with a mount pocket, and a vibrating device mounted within the pocket of the ring, wherein the vibrating device includes a massage pad driven in movement by an oscillating rod.

In some embodiments, the vibrating device includes a casing, a vibrating motor mounted with a resilient base inside the casing, and a power module. The resilient base may be a spring or a flexible plastic. The oscillating rod connects the massage pad to the motor. The oscillating rod may be mounted by sleeving over a portion of the motor.

In some embodiments, the oscillating rod extends through an opening of the casing. The oscillating rod in movement repeatedly hits a rim of the opening of the casing to generate vibrations. The vibrating device is thereby configured to make the ring vibrate and oscillate the massage pad. The massage pad exposes outward through an opening of the mount pocket of the ring. The massage pad can be configured to apply vibrations to a vaginal area.

In some embodiments, the power module includes a switch and a battery. The switch is operable to selectively connect the battery with the motor to turn on the vibrating device. In some variations, the switch may be a rotary or push switch.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a general schematic view of a vibrating condom ring according to an embodiment of the invention;

FIG. 2 is a cross-sectional view taken along section A in FIG. 1;

FIG. 3a is a schematic view of a vibrating device implemented in a vibrating condom ring according to according to an embodiment of the invention;

FIG. 3b is a view opposite FIG. 3a;

FIG. 4a is a schematic view of a vibrating device implemented in a vibrating condom ring according to another embodiment of the invention; and

FIG. 4b is a view opposite FIG. 4a.

### DETAILED DESCRIPTION OF THE EMBODIMENTS

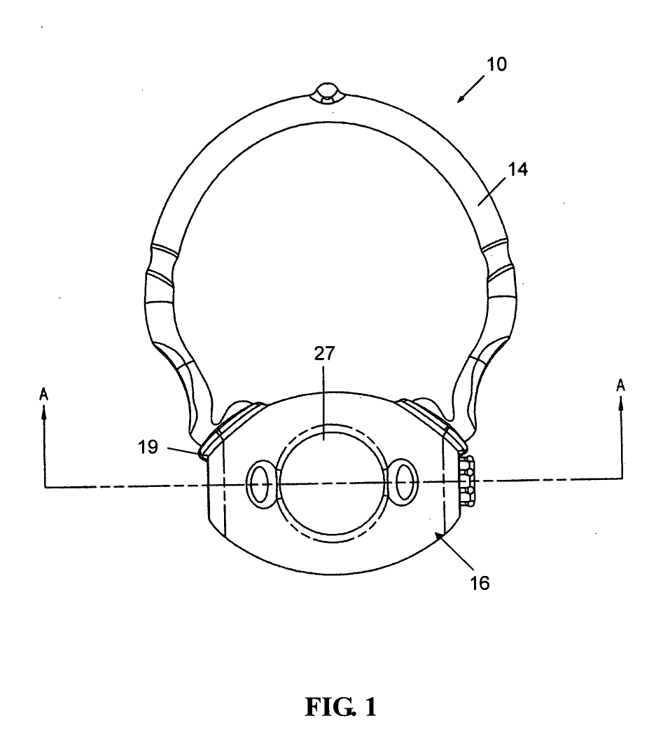

FIG. 1 is a schematic view of a vibrating condom ring according to an embodiment of the invention. Reference number 10 generally designates the vibrating condom ring, which includes a ring 14 and a vibrating device 16 mounted with the ring 14. For example, the vibrating device 16 may be installed inside a pocket 19 provided on a portion of the ring 14. The vibrating device 16 includes a massage pad 27 protruding outward through an opening of the pocket 19. In an embodiment, the pocket 19 can be made of rubber and molded with the ring 14 in a single piece. More generally, any flexible or elastic material can be suitable for making the ring 14 and pocket 19.

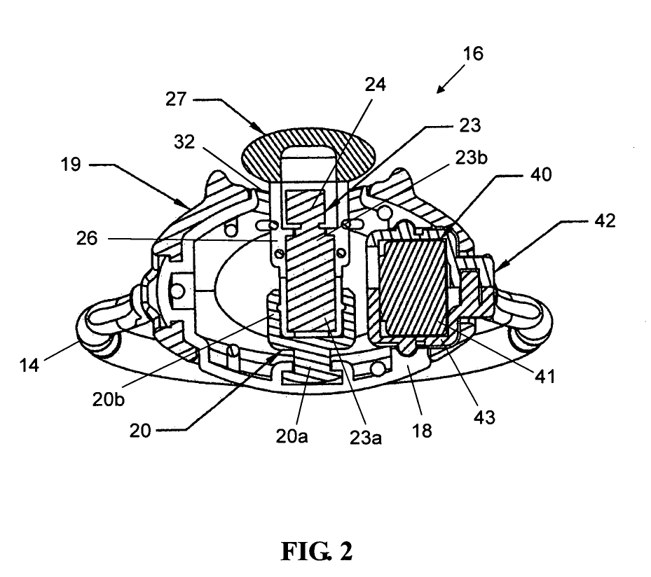

FIG. 2 is a cross-sectional view of a vibrating device implemented with a vibrating ring according to an embodiment of the invention. The vibrating device 16 includes a casing 18 in which are assembled a resilient base 20, a power module 40, a motor 23 having a rotor 24 with an eccentric mass, and an oscillating rod 26. The shape of the casing 18 may be generally oblong or oval to allow easier mount inside the pocket 19 of the ring 14. The power module 40 includes a switch 42 and a battery case 43 configured to lodge a battery 41 for supplying electric power to the motor 23. The battery 41 is preferably a flat battery. However, other types of power supply may be suitable.

As shown, the motor 23 is mounted on the resilient base 20 inside the casing 18. The resilient base 20 is configured to position the motor 23 inside the casing 18 while allowing its vibrating. In an exemplary embodiment, the resilient base 20 is formed in a single body by molding of a flexible plastic material, and has a first end 20a movably connected with a notch provided on the casing and a second end 20b which sleeves over a section 23a of the motor 23.

As shown in FIG. 2, the oscillating rod 23 includes a hollow portion in which a second section 23b of the motor 23 including the rotor 24 inserts. The motor 23 thus is securely positioned with the oscillating rod 26, so that the motor 23 when vibrating causes an oscillating movement of the rod 26. The oscillating rod 26 is connected with the massage pad 27, which extends and exposes outward through an opening 32 of the casing 18.

Preferably, the oscillating rod 26 is made of a rigid material for transmitting vibration to the massage pad 27. In turn, the massage pad 217 can be made of a flexible material and has a shape profiled to provide a soft and comfortable touch feeling. According to an implementation, the massage pad 27 can be made of a material composition including silica gel. However, other materials such as rubber, thermoplastics, or the like may also be suitable.

When turned on, the motor 23 drives the rotor 24 in rotation to produce vibrations. The created vibrations propagate through the casing 18 to the ring 14. Additionally, the movement produced by the motor 23 cause oscillation at a high frequency of the rod 26, which repeatedly hits the rim of the opening 32. The repeated collision of the oscillating rod 26 against the rim of the opening 32 creates vibration of the casing 18 and the massage pad 27. In an embodiment not illustrated, the rim of the opening 32 may be additionally provided with protruding beads to promote the generation of vibrations when it is hit by the oscillating rod 26.

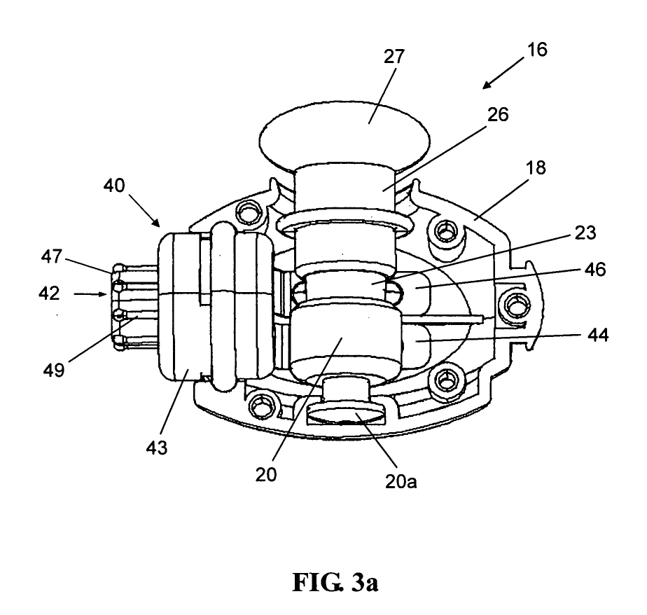

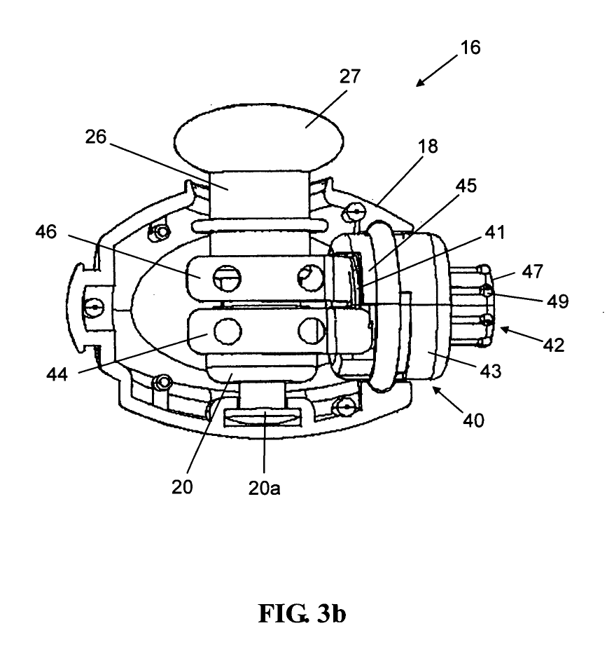

FIGS. 3a and 3b are opposite sectional views of an internal structure of the vibrating device, particularly showing the switching mechanism between the power module and the motor according to an embodiment of the invention. As illustrated, the power module 40 includes electrically conductive plates 44 and 46. The power terminals of the motor 23 are exposed through the resilient base 20 and the oscillating rod 26 for electrically connecting with the conductive plates 44 and 46 through conductive wires (not shown). In the embodiment illustrated in FIGS. 3a and 3b, the switch 42 is exemplary a rotary switch including a rotating button 47.

The switching circuit may be implemented through different ways. In the illustrated embodiment, the conductive plates 44 and 46 extend into contact terminals which are positioned relative to the battery case 43 to resiliently contact the positive and negative poles of the battery 41. The rotating button 47 is configured to drive an insulating flange 45 in rotation. The insulating flange 45 is configured to contact with the peripheral and bottom faces of the battery 41, which correspond to the positive and negative poles of the battery 41.

When the switch 42 is in an OFF state, the insulating flange 45 lies in a position interposed between the contact terminals of the conductive plates 44 and 46 and the positive and negative poles of the battery 41 to disconnect the electric circuit between the motor 23 and the battery 41. To turn the vibrating device on, a user turns the rotating button 47 to an ON state position, the movement of which causes the insulating flange 45 to disengage from the position between the conductive plates 44 and 46 and the electric poles of the battery 41. As a result, the terminals of the conductive plates 44 and 46 contact with the positive and negative poles of the battery 41 to establish an electrical connection and turn on the motor 23.

An advantage of the aforementioned design is that the conductive plates 44 and 46 are isolated from the electric poles of the battery 41 in the OFF state, which can prevent undesirable oxidation of these metallic parts which may be induced by mechanical contact between them. Additionally, the vibrating device can be easily and conveniently operated with a simple rotation of the button 47. To facilitate its hand manipulation, an outer surface of the button 47 may be provided with protrusions 49, as shown in FIGS. 3a and 3b.

The vibrating ring according to this invention may be used in many ways. According to one embodiment, the ring 14 may be placed so as to encircle a penis. During a sexual act, the vibrating device 16 can be turned on so as to generate vibrations in the ring 14, while the massage pad 217 additionally applies a vibrating contact on a sensitive area of the other partner (for example, a vaginal region of the female partner). The vibrating ring according the invention thus can bring fin and enhance the sexual stimulation.

It should be understood that the vibrating ring according to this invention is not limited to any specific use, and many use configurations are possible. In particular, the vibrating ring can be commercialized independently, or combined with a condom in a package product for inciting people to purchase and use condoms.

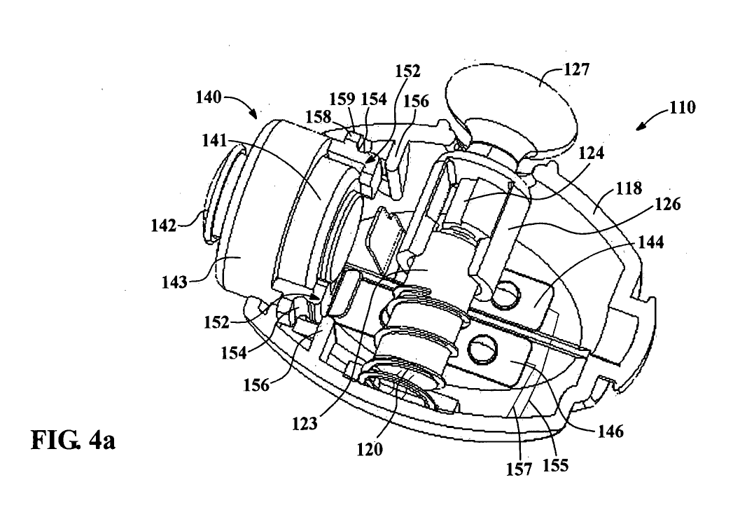

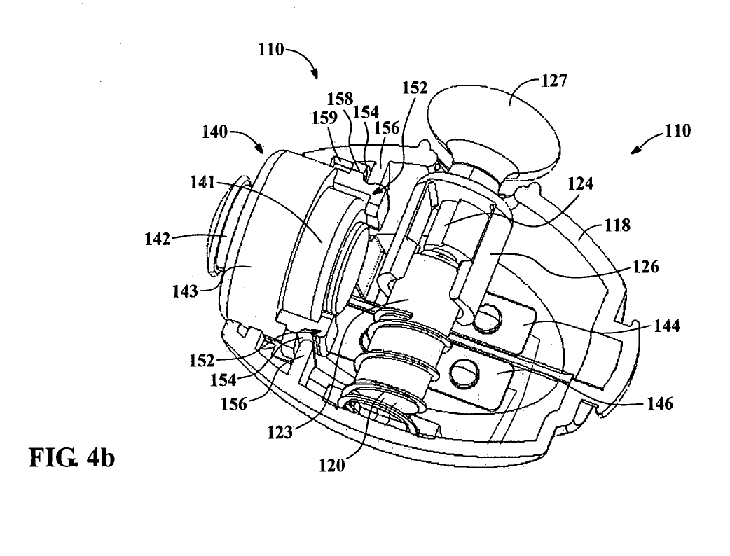

FIGS. 4a and 4b are schematic views illustrating a vibrating device suitable for use with a vibrating ring according to a variant embodiment of the invention. The vibrating device 110 includes a casing 118 in which are assembled a resilient base 120, a power module 140, a motor 123 having an eccentric mass rotor 124, and an oscillating rod 126. The vibrating device 110 can be associated with a ring as described above. In this embodiment, the resilient base 120 is a spring used to position the motor 123 within the casing 118. As the stiffness of the resilient base 120 modifies the vibration produced by the motor 123, the material and the type of the resilient base 120 can be generally chosen according to the desired degree of vibration set for the vibrating device. A massage pad 127 is also provided, which is connected through an oscillating rod 126 to the motor 123. The motor 123 is electrically connected with conductive plates 144 and 146 through electric wires 155 and 157, for example.

In the embodiment of FIGS. 4a and 4b, the power module 140 uses a pushing switch 142, and includes a battery case 143 for lodging a battery 141. Each conductive plate 144 and 146 extends into a contact terminal adjacent to the battery 141. The battery case 143 is movably assembled with the casing 118, and includes resilient flanges 152, each of which having a notch 154 configured to engage with a protrusion 156 provided on an inner surface of the casing 118.

In FIG. 4a, the switch 142 is in an OFF state. The position of the battery case 143 separates and disconnects the battery 141 from the conductive plates 144 and 146 to turn off the vibrating device 110. In the OFF state, the resilient flange 152 has a rib 158 that resiliently engages with a slot 159 of an adjacent portion of the casing 118, which can prevent the switch 142 from inadvertent slipping and turning the vibrating device 110 on.

In FIG. 4b, the switch 142 is in an ON state. As a user exerts a sufficient pushing force on the switch 142, the rib 158 disengages from the slot 159 and the battery case 143 slides and brings the electric poles of the battery 41 in contact with the conductive plate 144 and 146 to supply electric power to the motor 123. In the ON state, the protrusion 156 snap fits with the notch 154 to impede the return of the battery case 143 to the OFF state position. To turn off the vibrating device, the user exerts a pulling force on the switch 142 to disengage the protrusion 156 from the notch 154 and pull the battery case 143 back to the OFF state position, which disconnects the battery 141 from the conductive plates 144 and 146.

As described above, the present invention therefore provides a vibrating ring configured to apply a vibrating stimulation through at least two separate ways, which include a vibration of the ring and an oscillation and vibration of the massage pad. The vibrating ring according this invention thus can provide an improved sexual stimulation compared with the prior art devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A vibrating ring comprising:
a ring for encircling a penis and having a mount pocket; and
a vibrating device mounted within the pocket of the ring for generating vibrations, wherein the vibrating device includes a massage pad driven in movement by an oscillating rod.

2. The vibrating ring according to claim 1, wherein the vibrating device is configured to transmit vibrations to the ring.

3. The vibrating ring according to claim 1, wherein the massage pad is configured to apply vibrations to a vaginal area.

4. The vibrating ring according to claim 1, wherein the massage pad exposes outward through an opening of the mount pocket of the ring.

5. The vibrating ring according to claim 1, wherein the vibrating device includes a casing, a vibrating motor mounted with a resilient base inside the casing, and a power module.

6. The vibrating ring according to claim 5, wherein the oscillating rod sleeves over a portion of the motor.

7. The vibrating ring according to claim 5, wherein the oscillating rod extends through an opening of the casing.

8. The vibrating ring according to claim 7, wherein the oscillating rod in movement repeatedly hits a rim of the opening of the casing to generate vibrations.

9. The vibrating ring according to claim 5, wherein the resilient base is made of a spring or a flexible plastic.

10. The vibrating ring according to claim 5, wherein the power module includes a rotary or push switch, and a battery.

11. An apparatus for sexual stimulation comprising:
a vibrating device including a motor and a power module; and
a ring and a massage pad respectively connected with the vibrating device, wherein the vibrating device is configured to make the ring vibrate and the massage pad oscillate.

12. The apparatus according to claim 11, wherein the massage pad is movably mounted with the vibrating device.

13. The apparatus according to claim 11, wherein the ring is suitable for encircling a penis.

14. The apparatus according to claim 11, wherein the massage pad is configured to apply stimulation to a vaginal area.

15. The apparatus according to claim 11, wherein the motor is assembled in a casing placed in a pocket provided on the ring.

16. The apparatus according to claim 15, wherein the massage pad is connected with the motor through an oscillating rod.

17. The apparatus according to claim 15, wherein the motor is mounted inside the casing through a resilient base.

18. The apparatus according to claim 15, wherein the oscillating rod extends through an opening of the casing.

19. The apparatus according to claim 18, wherein the oscillating rod in movement repeatedly hits a rim of the opening of the casing to generate vibrations.

20. The apparatus according to claim 18, wherein the ring is made of rubber.
